(19) United States
(12) Patent Application Publication
(10) Pub. No.: US 2014/0297548 A1
(43) Pub. Date: Oct. 2, 2014

(54) METHOD AND COMPUTER FOR MATCHING CANDIDATES TO TASKS

(71) Applicants: Richard Wilner, Needham, MA (US); Noah Zitsman, Needham, MA (US)

(72) Inventors: Richard Wilner, Needham, MA (US); Noah Zitsman, Needham, MA (US)

(21) Appl. No.: 14/066,556

(22) Filed: Oct. 29, 2013

Related U.S. Application Data
(60) Provisional application No. 61/719,809, filed on Oct. 29, 2012.

(51) Int. Cl. G06Q 10/10; G06F 17/30

(52) U.S. Cl. CPC G06Q 10/1053; G06F 17/3053
USPC 705/321

(57) ABSTRACT

A method is performed upon a computer server in response to specific instructions stored on a non-transitory computer-readable medium. The method includes processing, within at least one server, a set of data to assess the skills and capabilities of an individual or collection of individuals within a company or collection of companies. The method considers multiple aspects of individual experience when assessing skills and capabilities, garnered from reports of experience stored electronically in a database connected to the server on which the method's processes are performed. The method is performed upon a computer server in response to specific instructions stored on a non-transitory computer-readable medium.

### BACKGROUND OF THE INVENTION

Sooner or later, every manager faces a similar people problem: selecting who is the best person to perform a necessary task. As part of a corporation, a senior executive will oversee others, such as vice presidents, managers, or unit heads. These people, in turn, may oversee others, and those people still others. Ultimately, because corporations have neither hands, brains, nor mouths, the corporation's work must be assigned as discrete tasks to individual workers, and each individual worker has a distinct and unique bundle of skills.

The adroit management by selection from among small variations in employees' unique capabilities can make a marked difference in their productivity—and in the company's performance. A manager's goal is to keep each employee as productive as possible at all times. This is accomplished by matching employees' assignments to their appetites and aptitudes. To describe the magnitude of this necessary selection task, consider the following: sorting out the possibilities for assigning even ten employees to ten positions confronts the manager with a number of permutations expressed as ten factorial; i.e., over 3.6 millions. One of these permutations is optimal, and the manager's mission is to find this single optimal permutation from among the 3.6 million. Further, consider that these ten employees may represent only a single echelon of the organization chart. As additional echelons are considered and optimized, the magnitude of the number increases geometrically as tasks are delegated from one level to the next, to managers' direct reports and to their direct reports. Finding the optimum match between employees and tasks quickly becomes simply unmanageable.

Faced with so many permutations of employee-to-task assignment, of which only some are acceptable and only one is optimal, most companies abandon any attempt to base the selection on regimen or in any meaningful way to allow rational choices to aid in making matches. Assignments, instead, become a matter of intuition, personal likes and dislikes, chance meetings, and simple guessing. In such a setting, an employee's actual proclivity for performing a task is necessarily disconnected from the act of assigning employees to tasks. The effect is that managers either treat people with diverse attributes as undifferentiated, or do not differentiate on the proper attributes. In either case, these companies forfeit the chance to make substantial gains in productivity and profitability. Further, the company discourages, rather than encourages, the personal development of its personnel.

A manager who wants the best people to do their best work must anticipate and fulfill the company's workforce requirements, react quickly to a changing work environment, and reward employees for both easily measurable (i.e. percent billable) and difficult-to-measure (i.e. customer satisfaction) contributions. To that end, enterprises may have a database that is populated with data asserting experience and skills in a manner to generally inform workforce allocation decisions. This database often consists of an artificially narrow group of search terms. Because the database can only be searched with such terms as it might, executives and managers find that they cannot measure and compare skills and proficiencies easily. Further, terms that are not reflected in the database cannot be searched, measured, or compared at all. Finally, consider that each individual worker possesses a multitude of capabilities, each of which will be represented by a term in the database. Unless meaningful connections between the myriad database terms exist, the act of sorting and filtering using the terms can be, itself, unmanageable. The result is that the executives and managers then come up empty-handed, and the company fails to understand which employees are essential or how best to structure their work force both strategically (i.e., what employees do we need) and tactically (where to optimally deploy our current employees today, tomorrow, and next week). As a result, the optimized application of human capital—the skills and knowledge of employees—too often remains an untapped performance lever.

What the art lacks is an apparatus for, and method of, extracting from the stored data a set of indicia to be used in measuring and rating candidates based upon skills and experience, which can then be used to create and deliver a hierarchical list of candidates that represents the best matches for a particular task (or set of tasks).

### SUMMARY OF THE INVENTION

A method is performed upon a computer server in response to specific instructions stored on a non-transitory computer-readable medium. The method includes processing, within at least one server, a set of data to assess the skills and capabilities of an individual or collection of individuals within a company or collection of companies. The method considers multiple aspects of individual experience when assessing skills and capabilities, garnered from reports of experience stored electronically in a database connected to the server on which the method's processes are performed. These and other examples of the invention will be described in further detail below.

### BRIEF DESCRIPTION OF THE DRAWINGS

Preferred and alternative examples of the present invention are described in detail below with reference to the following drawings:

FIG. 1 is an overview flow chart indicating a method to calculate a suitable rating of skill scores for the experience a candidate possesses;

FIG. 2 is a first detail flow chart, expanding a first block of the overview set forth in FIG. 1, relating a method of evaluating past experience of a candidate;

FIG. 3 is a second detail flow chart, expanding a first block of the first detail flow chart set forth in FIG. 2, relating a method of calculating a first look-up value for weighting the experience;

FIG. 4 is a third detail flow chart, expanding a second block of the first detail flow chart set forth in FIG. 2, relating a method of calculating a second look-up value for weighting the experience;

FIG. 5 is a fourth detail flow chart, expanding a third block of the first detail flow chart set forth in FIG. 2, relating a method of calculating a third look-up value for weighting the experience;

FIG. 6 is a matrix framework for weighing the value of the longevity and frequency of skill use;

FIG. 7 is a set of detail matrices, based on the framework set forth in FIG. 6, for weighing the value of the longevity and frequency of skill use;

FIG. 8 is a representative set of curves that can be used to interpolate the values of the matrices set forth in FIG. 7;

FIG. 9 is a detail flow chart, expanding a third block of the first detail flow chart set forth in FIG. 2, relating a method of calculating a fourth look-up value for weighting the experience;

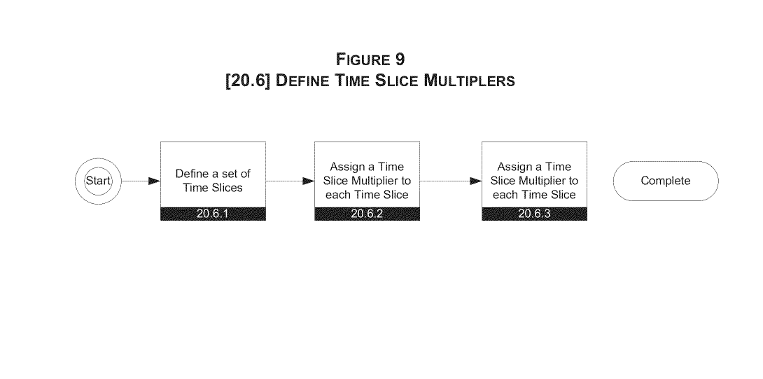

FIG. 10 is a detail flow chart, expanding a third block of the overview set forth in FIG. 1, relating a method of synthesizing a single skill rating based on reports of experience.

FIG. 11 is a detail flow chart, expanding a fourth block of the overview set forth in FIG. 1, relating a method of calculating similarity relationships amongst the myriad skill descriptors that are accessed and utilized by the method.

FIG. 12 is a detail flow chart, expanding a first block of the detail flow chart set forth in FIG. 11, relating a method of calculating the similarity relationships amongst the myriad skills residing within a database.

FIG. 13 is a detail flow chart, expanding a second block of the detail flow chart set forth in FIG. 11, relating a method of assigning similarity ratings amongst the myriad skills present in an individual's reports of experience.

### DETAILED DESCRIPTION OF THE PREFERRED EMBODIMENT

Most businesses strive to keep some form of database record of the capabilities of every worker in their employ. There are multiple reasons for this. A first reason, by way of example, is that a subset of the employees, the skills and experiences of whom can vary across business units and may change as a company evolves, always plays a disproportionate role in creating value, and the business will benefit from identifying this high-performing group. Another reason, by way of example, is that special qualifications may be required for certain tasks and jobs, such as performing as a labor negotiator, a master electrician, or a medical doctor.

Some methods exist to capture and track employee skill sets, historical assignments, and capabilities. One method of differentiating between employees is to assign individual employees to arbitrary categories based on role, such as engineer or laborer, or title, such as manager or staff worker. This method can be problematic when an employee does not fit well into any available group or fits into multiple groups. Another method is to keep an inventory of resumes or keywords, either in paper copy file or in an electronic database. This method can also be problematic in several ways; for example, because it has no provision to compensate for a multitude of representations for a single skill or capability, and further, paper resumes become difficult to manage in large numbers, and keywords often provide speed of search at the expense of context.

A method and computer for systematically and repeatedly scanning and reporting on an employee's capabilities includes the systematic collection of information about a past, current, or potential employee. From a moment well before an employee is hired for a job or assigned a task in performance of a job, an employee generates information that will suitably assist in identifying an optimal match between the company's available tasks and that employee's capabilities. Further, as long as that employee is working, they will continue to generate this type of information. Still further, to sort from among several prospects to hire or assign, a manager must know what tasks the employer needs performed.

The method 1 examines any information that is available in a form that is machine-readable. While the method 1 is not limited to resume-type information, examining the method 1 by using such information as a non-limiting example of the sort of information that is available to the method 1 is illustrative in explaining the method.

Experience using specific skills and skill combinations is placed in machine readable form at any of the steps 10A, 10B, and 10C, which differ not necessarily in the method of data entry but are distinct in terms of the source of the information there collected. As set forth in the explanation of evaluation of information collected below, the source of data lends a reliability rating to each particular datum.

Because matching previous roles, job titles, or other information is not necessarily, by itself, indicative of an optimal candidate-to-task match, the presence of performance data is encompassed in the reliability rating. In short, although a candidate may possess many years of experience in a similar role or identical job title, they might lack the experience with the skills and skill combinations required for a specific task.

For the purposes of the method 1, experiences in a candidate's past are evaluated by rating the individual skills reflected in the candidate's experience and scoring the presence of a skill based upon fixed criteria. The following aspects of skill use are primarily considered:
How frequently a skill was used (rewards using the same skill on multiple projects);
How continually a skill was used (rewards using a skill consistently over a period of time);
How intensely a skill was used (rewards using a skill critical to task success); and
How recently a skill was used (penalizes skills that languish over time).

Although an individual may not have experience with a specific skill or collection of skills, they may have the ability to either quickly learn, or directly use, skills that are similar or related to the skills that form the individual's basis of expertise. For example, a master carpenter who has built furniture and fixtures for domestic houses can be expected to become quickly adept at producing seaworthy wooden hulls for boats. Similarly, a computer programmer with a career focused on a single programming language will become conversant with additional languages much more quickly than a layperson unfamiliar with computer programming concepts. Identifying these approximate matches to a set of task, project, or job requirements can be of tremendous benefit to an enterprise, for it allows that enterprise to both utilize and develop its existing skilled resources, while simultaneously avoiding the risk, expense, and delay required to source, recruit, and hire new resources.

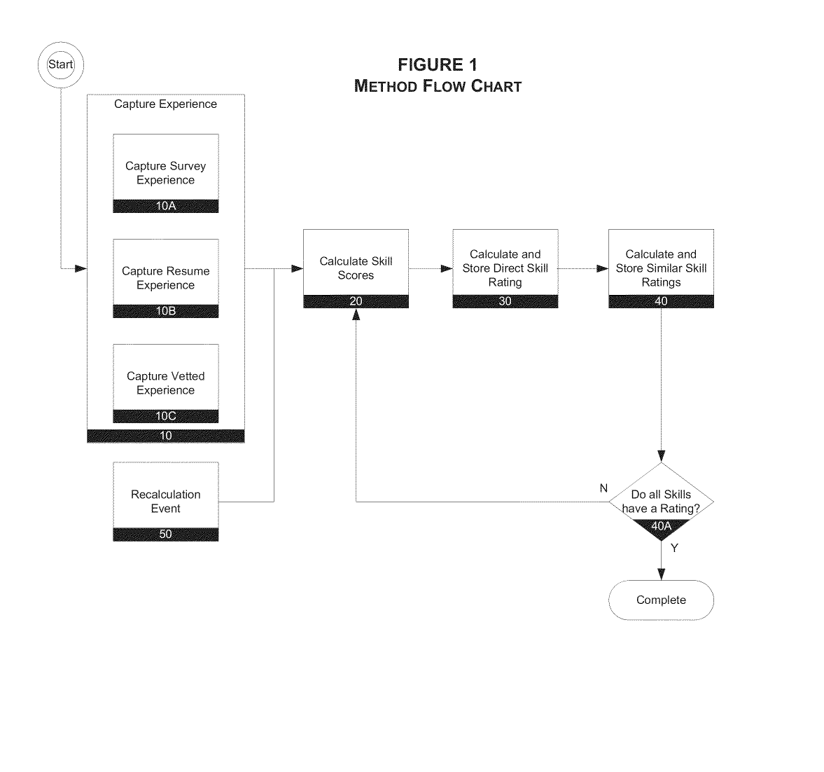

FIG. 1 is an overview flow chart indicating a method 1 to calculate suitable Skill Ratings (i.e. quantitative measures of skill aptitude) for the experience a candidate possesses.

At a block 10, the systematic capture of a candidate's experience is accomplished by one of several alternate means: survey means at a block 10A; non-vetted experience reports at a block 10B; or vetted experience reports at a block 10C. Any suitable method can be used to capture experience, by way of non-limiting examples: importing data from an existing database, or scanning and processing data from a resume or set of resumes. The use of one of the alternative means does not prevent additional use of a second or, indeed, any and all available alternative means to capture an employee's skills and experience.

At a Survey Experience Block 10A, the candidate self-identifies a list of skills they possess (through a survey or other suitable means). Because a candidate's asserting possession of a particular skill is, by nature, self-identified and lacks context, a catalog of experience collected at the Survey Experience Block 10A contributes the least reliable information used to lend insight into a constellation of skills the candidate possesses. To suitably evaluate the information as being a nonnegative contribution to the knowledge the method 1 collects, a small coefficient is assigned to asserted experience garnered at the Survey Experience Block 10A.

At a Non-Vetted Experience Block 10B, the candidate creates reports of experience; i.e., past successful performance of tasks. The method will then assign a rating for every discernible skill present in these reports as the method 1 incorporates these reports into a machine-readable catalogue of the candidate's skills. These experiences are self-reported by the candidate, but in contrast to those set forth in the Survey Experience Block 10A, at the Non-Vetted Experience Block 10B, the method receives the candidate's reports of experience solely in the context of exemplary or canonical project descriptions, which minimally consist of a list of required skills, a duration of use of those skills, and optionally, the proportional importance of each skill to the successful completion of that project. Because of the additional objective detail the candidate must provide to the method 1, machine readable data reflecting a candidate's experience collected at the Non-Vetted Experience Block 10B contributes a medium amount of reliable information to lend insight into the constellation of skills the candidate possesses. To suitably evaluate the information as being a nonnegative contribution to the knowledge the method 1 collects, a medium coefficient is assigned to of the asserted experience garnered at the Non-Vetted Experience Block 10B.

At a Vetted Experience Block 10C, experience collected in the form of machine-readable data is recognized as having been vetted in some manner. Vetting is defined as any investigative processes by which any information a candidate provides is verified by independent sources. In some instances, a regimented system exists for verifying the information a candidate provides, in others, vetting might be provided on an ad hoc basis. Because the data placed into machine-readable form at the Vetted Experience Block 10C is credible and has context, the data so collected at the Vetted Experience Block 10C contributes the most reliable information to lend insight into the constellation of skills the candidate possesses. To suitably evaluate the information as being a nonnegative contribution to the knowledge the method 1 collects, a large coefficient is assigned to the experience data garnered at the Vetted Experience Block 10C.

It should be noted that when specifying skills in blocks 10A, 10B, and 10C, an organization would be well-served to use a common catalog of skill descriptors. This will enable correlation to be more easily drawn between individual experiences (and constituent skills). A business is highly motivated to construct and maintain a catalog of skill descriptors relevant to the positions that are required of each position in the past, present, and anticipated (i.e. future) organizational charts. This list of skills can form the basis of myriad efforts to streamline the workforce and positively impact the company's productivity and profitability, for example: finding overlapping positions; creating job and project requisitions; identifying and tracking employee skillsets. Because of the economic motivation, there often already exists some type of skill descriptor database that can be readily used for the purposes in Block 10.

As described above, the method 1, or a computer implementing the method 1, exploits the information captured in block 10 when determining an individual's aptitude with the skills present in their experience reports, i.e., Skill Ratings. The method 1 further exploits reports of experience by measuring the machine readable data reflecting the presence of a skill by comparing that data to a predefined model of that skill. The model represents a scoring means to evaluate the skill's frequency of use, duration of use, intensity of use, and “recent-ness” of use.

At a Calculate Skill Scores Block 20, these measured attributes of skill use are synthesized into a set of Skill Scores such that for each enumerated skill a candidate possesses, based upon the data garnered at block 10, the candidate is given a score representing how reliably the candidate can perform a task that includes the use of that skill.

In fact, at Block 20, the candidate receives a pair of scoring criteria for each skill identified at the Block 10: a Longevity Score and a Frequency Score. These two scores are different quantitative measures of aptitude with reference to an enumerated skill. A high Longevity Score is awarded if the experience indicates the candidate has garnered the skill while working on a small number of long-term projects using the skill. A high Frequency Score is awarded if the experience indicates the candidate has garnered the skill while working on a large number short-term projects using the skill. Both Scores will reward intense or continuous use of a skill, and penalize incidental use of a skill.

Thus, for each enumerated skill identified at the block 10, an ordered pair of scores are assigned to the candidate (i.e. Longevity and Frequency Score pairs); the method 1 generates the ordered pair relative to the skill and synthesizes these pairs into a Skill Rating. Each discrete ordered pair is assigned to the candidate and stored by the method at a Calculate and Store Direct Skill Rating Block 30. At a Decision Block 40A, the method compares the list of stored skill ratings to the list of enumerated skills garnered from experience reports at Block 10 to determine if each skill has a current corresponding ordered pair. In the event that the experience reports for a specific skill garnered at the Block 10 have yet to be synthesized into a skill rating, the method will execute the Skill Rating construction process described by Block 20 and Block 30.

Where there are multiple experiences reflecting use of a particular skill, the set of Skill Scores discerned in Block 20 are synthesized into a single Skill Rating ordered pair with reference to both the Frequency Score and the Longevity Score, as is further described below with reference to the time slicing.

As stated previously, adeptness with a specific skill affords an individual a spectrum of familiarity and capability with the constellation of skills that are similar to that specific skill. The degree to which an individual can suitably perform a task with a skill that is similar to, but not directly in the realm of, their body of experience is primarily a function of how similar the skill in question is to the skills with which the individual has direct expertise. To extend the example previously set forth, a domestic carpenter may have skills that are similar to those required for wooden marine craft construction, but his body of experience would be less suited to tasks requiring welding and fitting pipe, and the carpenter's skillset would likely be more well-suited to pipe fitting than reviewing legal contracts. Stated differently: a “domestic carpentry” skill is very similar to a “wooden hull construction” skill, somewhat similar to a “pipefitting” skill, and not at all similar to a “contracts review” skill.

To assess how similar a certain skill is to a skill that appears in an individual's reports of experience, the Method 1 considers myriad dimensions of similarity. The Method 1 first individually assesses these different similarity dimensions to form a set of similarity dimension scores, and then synthesizes the set of scores into a single Similarity Score. At a Calculate and Store Similar Skill Ratings Block 40, the Method 1 both identifies skills that are similar to those skills present in the individual's reports of experience, and assesses the degree to which these skills are similar in the form of Similar Skill Ratings.

Once all skills, and all experiences reflective of that skill, are aggregated to form a full set of composite Direct Skill Ratings and Similar Skill Ratings, the method is complete.

The method 1 has an additional strength and flexibility based upon its iterative nature. Over time, the loop comprising blocks 20, 30, and 40 can be reinitiated where knowledge of new experience is added at the block 10 for further aggregation in the candidate's set of composite skill ratings. If, for example, a candidate's experience changes (new skills added, existing skills have languished), the Skill Scores and Skill Ratings can be recalculated by the method 1, or by a computer implementing the method 1, at Block 50.

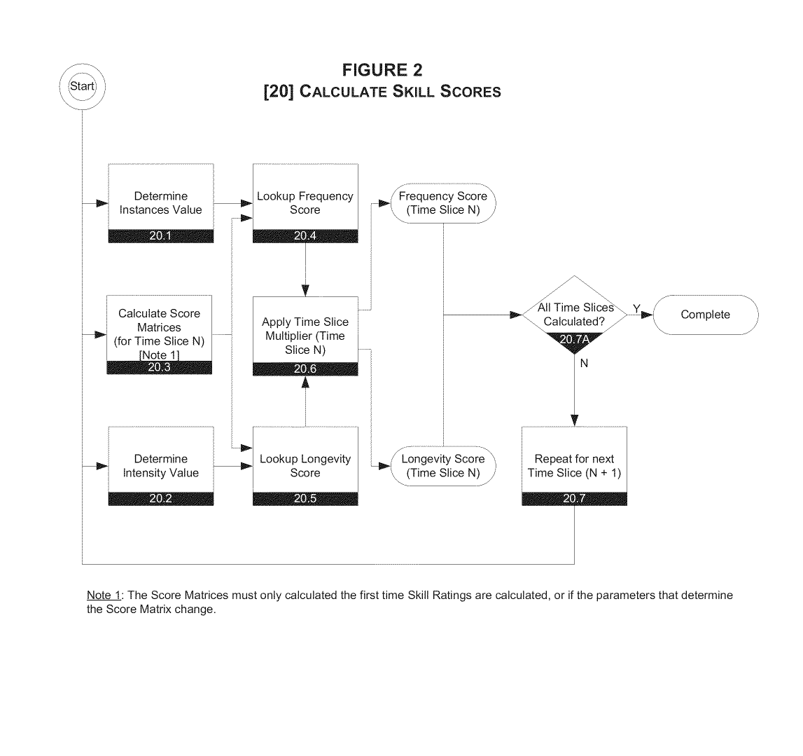

FIG. 2 is a first detail flow chart, expanding the Block 10 set forth in FIG. 1, where the method 1 evaluates machine-readable data garnered at Block 10 reflective of past experience of a candidate. To evaluate a task within the machine-readable data, the method 1 applies a scoring rubric is based on the notion that a person's adeptness with a skill is very highly correlated with the utilization of that skill. Utilization can take several forms, and is measured by the method 1 as follows.

At a block 20.1, the number of instances of skill use across the aggregate experience reports is measured. The number of instances of skill use may be grouped together, or “quantized”, to generate an aggregate score look-up table. By way of non-limiting example, 0 to 4 skill instances may result in a score of 1, 5 to 8 skill instances may result in a score of 2, 9 to 12 skill instances may result in a score of 3, and 12 or greater skill instances may result in a score of 4. This quantization can mitigate the complication of incorporating this measure.

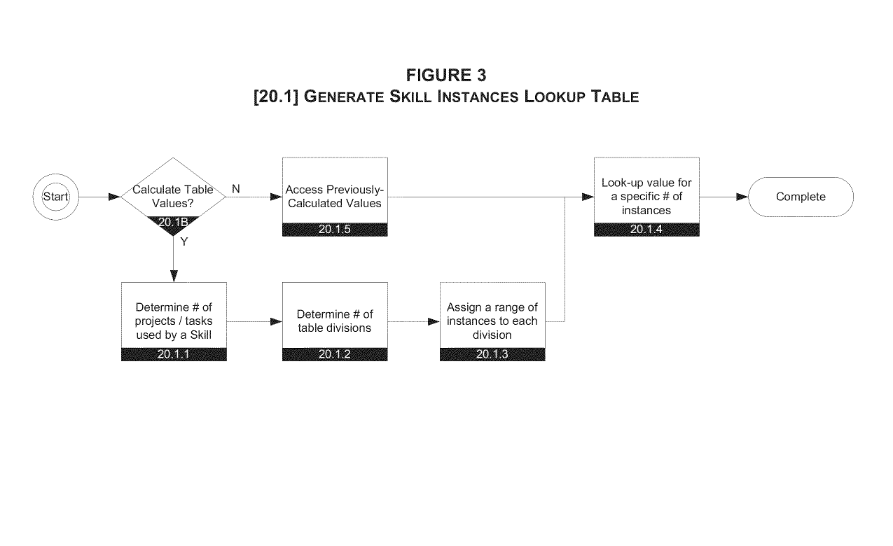

FIG. 3 is a detail flow chart expanding the method 1 at block 20.1 in order to suitably produce a look-up table for a skill that may or may not have been earlier catalogued for evaluation. In such an instance, a level is selected to represent mastery of the skill. Mastery, as used herein, is the point at which further or more frequent repetition of a skill is not likely to produce a further competency in the use of that skill. To that end, at a block 20.1.1, a number of instances of use of a skill is garnered from projects or tasks in which the use of that skill is necessary to complete the project or task. At a block 20.1.2, a meaningful number is selected for use by the method to represent gradations of mastery. So, for example, five divisions in a table may be adequate to show progress toward mastery. Such divisions might, for example, represent: “unskilled”; “cognizant”; “able to assist”; “apprentice”; and “journeyman”. For other skills, such as flying an airplane, the brackets may simply be a recitation of hour ranges in the relevant airframe.

At a block 20.1.3, where a certain level is accepted as “mastery” the intermediate levels can be suitably characterized to properly reflect the divisions determined in the block 20.1.2.

At a block 20.1.4, the method evaluates a specific candidate against the division criteria defined by Blocks 20.1.1, 20.1.2, and 20.1.3.

The values resulting from division criteria calculations at Blocks 20.1.1, 20.1.2, and 20.1.3 may be somewhat static. For example, the method 1 may evaluate a class of similarly-skilled employees, for example, database administrators at a computer programming consultancy. In this case, the division criteria will likely be identically applied to all those employees' reports of experience, and utilizing previously-calculated values may be preferable in order to save time and computing bandwidth on a computer implementing the method 1. At a Decision Block 20.1B, the method 1 either utilizes previously-stored values, which are accessed at an Access Previously-Calculated Values block 20.1.5, or calculates new values. If the method 1 is then employed to evaluate a different type of skilled resource at a later time, the method 1 can “recalibrate” itself to the task at hand by recalculating the division criteria values determined at Blocks 20.1.1, 20.1.2, and 20.1.3.

At a block 20.2, the intensity of skill use across the aggregate experiences is measured. The intensity measurement is informed by two qualities of skill use: first, the criticalness of that skill to task success, and second, the time spent using that skill during the performance of a task.

A skill is critical when the use of that skill is necessarily associated with the performance of one task or several tasks a position comprises. The method ascribes a measure of criticalness based on how important each individual skill is to successfully performing a specific component of the experience report using a pre-defined scale. By way of a non-limiting example, a skill that was essential to the completion of a task may be ascribed a 4 out of 4 criticalness measure, but a skill that was incidental or complementary may be ascribed a 1 out of 4 criticalness measure.

The method uses time spent to help determine the predominance of the use of a particular skill in the course of performance of a position. As with criticalness, the time spent is a quantity supplied to the method. One way to measure time spent is to exploit the data contained in the experience report. By way of a non-limiting example, skills that are reported to have been used greater than 0 but less than 10 hours a week may result in a score of 1, 10 or more hours but less than 20 hours per week may result in a score of 2, 20 or more but less than 30 hours per week may result in a score of 3, and 30 or greater hours per week may result in a score of 4.

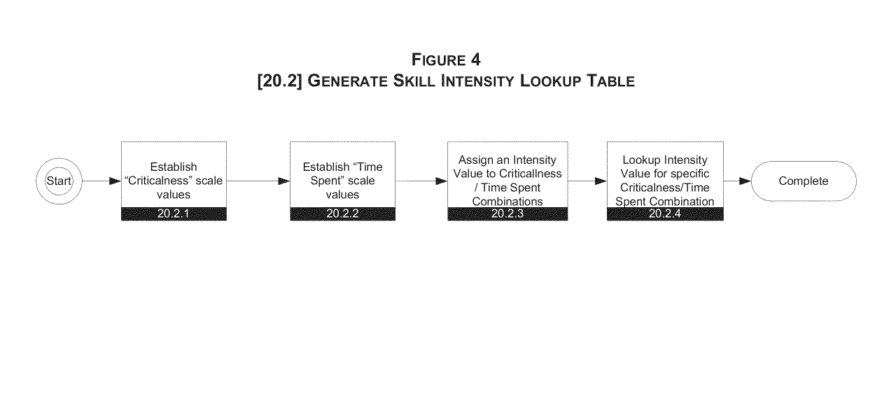

FIG. 4 is a detail flow chart expanding the method 1 at block 20.2 in order to suitably produce a look-up table to select an intensity measure for a skill. Intensity, as used herein, is a value synthesized from a skill's criticalness and the time spent using a skill.

To that end, at a block 20.2.1, the method establishes a scale for criticalness values that corresponds to the manner in which criticalness reports are captured and represented in all of the experience reports that contain a skill.

At a block 20.2.2, the method establishes a scale to represent the time spent using a skill, the values for which is garnered from all of the experience reports that contain a skill.

At a block 20.2.3, the method generates a look-up table to assign intensity values to the various possible combinations of criticalness values and time spent values.

At a block 20.2.4, the method examines the reports of experience to collect and synthesize a criticalness and time spent value for a specific skill present in an individual's reports of experience, and selects an Intensity value from the lookup table generated in block 20.2.3, previously set forth. If a single skill appears in multiple reports of experience, these reports can be synthesized through any suitable means, for example, arithmetic averaging.

Two persons who are equally proficient with a skill may have developed that proficiency through different and varied experiences. By way of a non-limiting example, consider two plumbers of equal proficiency; the first plumber may have completed piping installations in 100 residential houses over a one-year period, whereas the second plumber may have completed installations in 3 large industrial buildings over that same period. In this example, multiple dimensions of skill measurement much be considered to arrive at an accurate understanding of skill proficiency: completing a large number of small projects, such as in the case of the first plumber, yields a similar proficiency to completing a small number of large projects, as in the case of the second plumber. The preferred type of experience is not obvious, and would depend heavily on the type of work one needed to have completed. At a Block 20.3, the method 1 accounts for the varied types of experience that may be present in individuals' reports by defining and utilizing look-up tables.

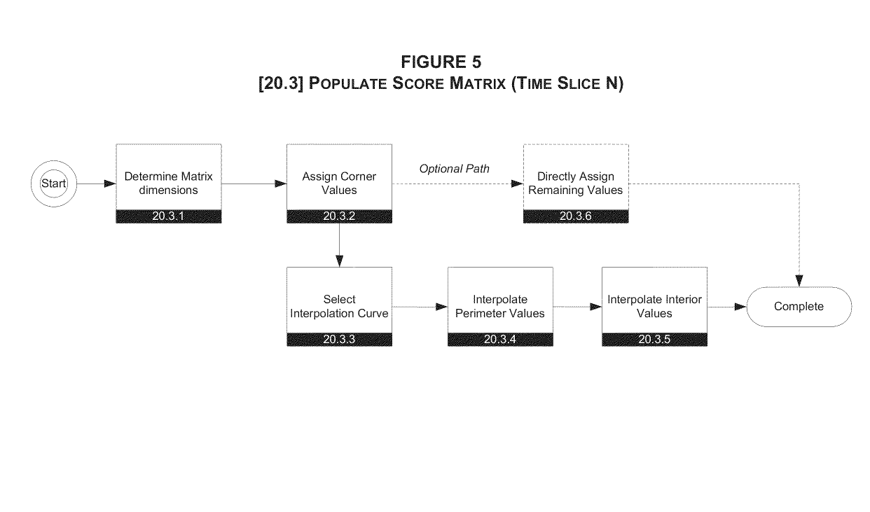

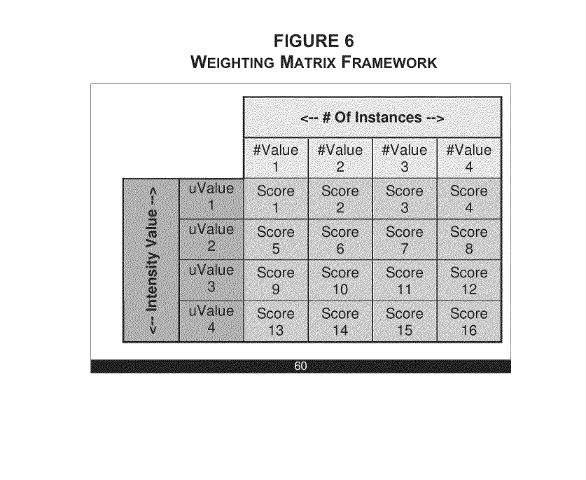

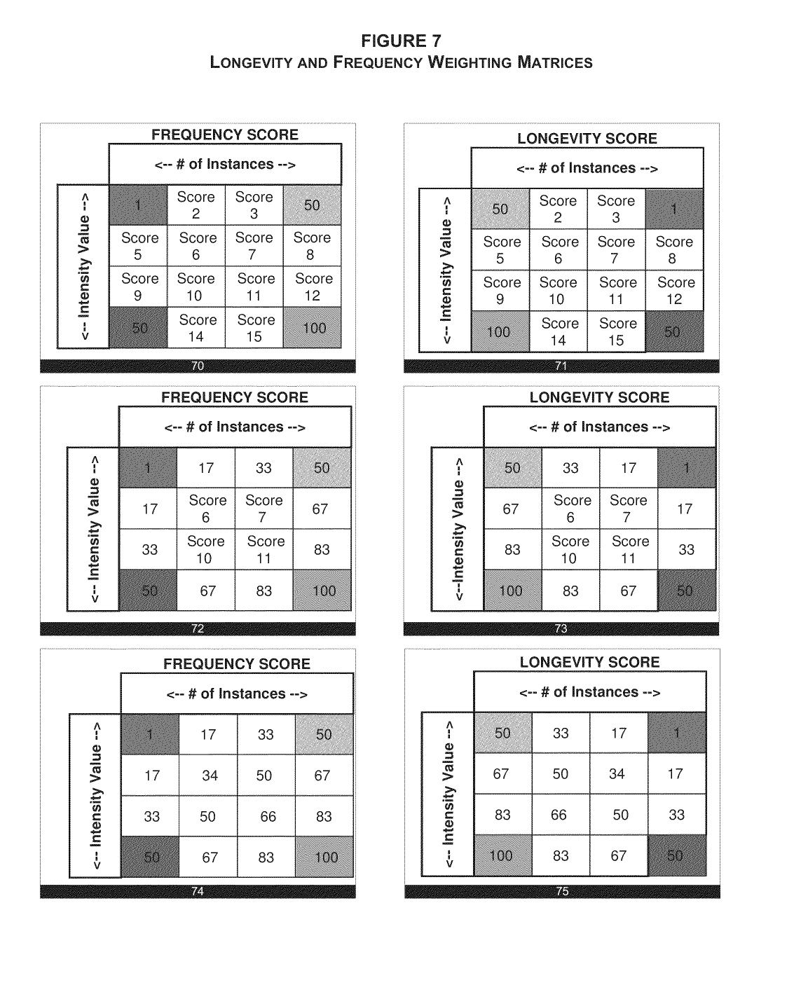

FIG. 5 is a detail flow chart expanding the method 1 at block 20.3 in order to suitably produce look-up tables to synthesize a rating for a skill based on multiple dimensions of skill measurement. FIG. 6 is an example of a blank look-up table whose values will be defined by the method. FIG. 7 shows the progression of the look-up tables used by the method, as those tables are fully populated for use by the method.

At a block 20.3.1, the method defines the dimensions of the look-up tables, or, as the term is used herein, matrices.

At a block 20.3.2, the method defines the values in the four corners of the look-up tables. The method employs two separate look-up tables to interpret the experience reports and synthesize a rating for a skill. The first look-up table rewards experience with a skill garnered by intense use of a skill on a large number of projects. In this look-up table, skills that have a high intensity rating and a high frequency of use across the reports of experience would receive a high skill proficiency rating. As either the intensity level or frequency of use decreases, the resulting skill proficiency rating would also decrease. Block 70 is an example of a look-up table whose corner values would generate skill proficiency ratings that reward intense use of a skill across many projects, where the value of Score 16 is the maximum possible score and the value of Score 1 is the minimum possible score. The resulting value generated by method using this look-up table will be called the “Frequency Score.”

The second look-up table rewards experience with a skill garnered by intense use of a skill on a small number of projects. In this look-up table, skills that have a high intensity rating and a low frequency of use across the reports of experience would receive a high skill proficiency rating. As either the intensity level decreases or frequency of use increases, the resulting skill proficiency rating would also decrease.

Block 71 is an example of a look-up table whose corner values would generate skill proficiency ratings that reward intense use of a skill across a small number of prolonged projects, where the value of Score 13 is the maximum possible score and the value of Score 4 is the minimum possible score. The resulting value generated by method using this look-up table will be called the “Longevity Score.”

Now that the method has defined the values in the 4 corners of both the “Frequency Score” lookup table and the “Longevity Score” lookup table, the method defines the remaining values of these tables. In the case of either Longevity Score lookup table or the Frequency Score lookup table, progressing along the diagonal from the minimum score to the maximum score will result in an increase in intensity of skill use. Progressing along this same diagonal for the Longevity Score lookup table results in a decrease in the frequency of skill use. Progressing along this same diagonal for the Frequency Score lookup table results in an increase in the frequency of skill use. As such, progressing along the diagonal from the minimum to the maximum score value in either lookup table will result in progressively higher score values because that progression indicates a more proficient set of experiences with a skill.

At a block 20.3.6, the remaining values in the two lookup tables are chosen directly by the method.

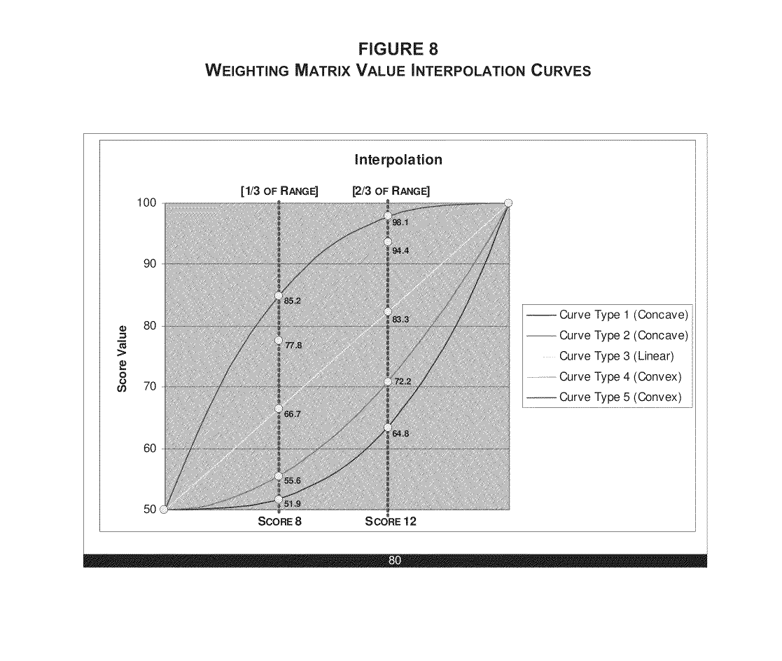

As an alternative to directly choosing the values at block 20.3.6, the method may choose a set of mathematical curves to interpolate the remaining, “non-corner” values in the lookup tables. At a block 20.3.3, the method chooses a mathematical curve to interpolate the remaining values in the two lookup tables. FIG. 8 shows example curves that might be used for interpolation, where Score 8 and Score 12 of the Longevity Score lookup table are shown to illustrate several possible resultant interpolated values that may be used by the method.

At a block 20.3.4, the method uses the curve chosen in block 20.3.3 to interpolate the outermost, or perimeter, values (Score 2, Score 3, Score 5, Score 8, Score 9, Score 12, Score 14, and Score 15) in the Longevity Score and Frequency Score lookup tables. By way of a non-limiting example, Block 72 and Block 73 show the two resultant lookup tables if the method chose a linear interpolation curve.

At a block 20.3.5, the method uses either the same curve chosen in block 20.3.3 or a different curve to interpolate the interior values (Score 6, Score 7, Score 10, and Score 11) of the Longevity Score and Frequency Score lookup tables. Note that each interior value will have two interpolated values: one from the row interpolation, and one from the column interpolation. The method combines these two interpolated values in any suitable manner; for example, through a simple arithmetic average. Block 74 and Block 75 show the resultant lookup tables if the method chose a linear interpolation curve and a simple arithmetic average to populate the interior values.

Once the method has fully defined the values in the Longevity Score and Frequency Score lookup tables, the method utilizes those tables to assign scores to the skills present in an individual's reports of experience. At a Block 20.4, the method utilizes the instances value and intensity value garnered at block 20.1 and block 20.2 to determine a Frequency Score based on the Frequency Score Matrix established at block 20.3. Similarly, at a Block 20.5, the method utilizes the instances value and intensity value garnered at block 20.1 and block 20.2 to determine a Longevity score based on the Longevity Score Matrix established at block 20.3.

As skills go unused, an individual's aptitude with that skill languishes. For example, consider two open-heart surgeons of equal ability, both of whom have performed 90 surgeries with identical sets of outcomes. The first surgeon has performed 50 of these surgeries in the past year; however, the second surgeon has moved into an administrative role and has not performed any surgeries in the past 5 years. Despite the fact that both surgeons have equal experience, the first surgeon is more likely to produce a successful outcome due to the recent nature of his experience. At a block 20.6, the method accounts for this phenomenon when ascribing scores to the skills present in the various reports of experience. FIG. 8 is a detailed flow chart, expanding the block 20.6 in FIG. 2, which describes how the method considers the time-based aptitude phenomenon.

At a block 20.6.1, the method defines a set of “Time Slices,” or contiguous durations each of which contains a start date and an end date, except for the final time slice which will have a definite start date but may have an indefinite end date (encompasses all time before a certain date).

At a block 20.6.2, the method assigns a value to each of the “Time Slices” defined in block 20.6.1 such that those durations encompassing time periods in the more distant past are assigned smaller values.

At a block 20.6.3, the method examines the reports of experience to determine into which time slice the reports of experience lie, and applies the appropriate time slice multiplier to the Longevity and Frequency scores associated with those reports of experience.

At a decision block 20.7A, the method determines if reports of experience have been considered for all time slices garnered at Block 20.6. If there are one or more time slices that have yet to have Longevity and Frequency scores determined, the method examines the reports of experience for the next time slice in the set of contiguous time slices. The method will complete this process until it computes the Longevity Score and Frequency Score for all defined “Time Slices.” After this step, each skill will have a complete set of Skill Scores (i.e. a Longevity Score and a Frequency Score); one set for each “Time Slice” in which an experience report containing that skill resides.

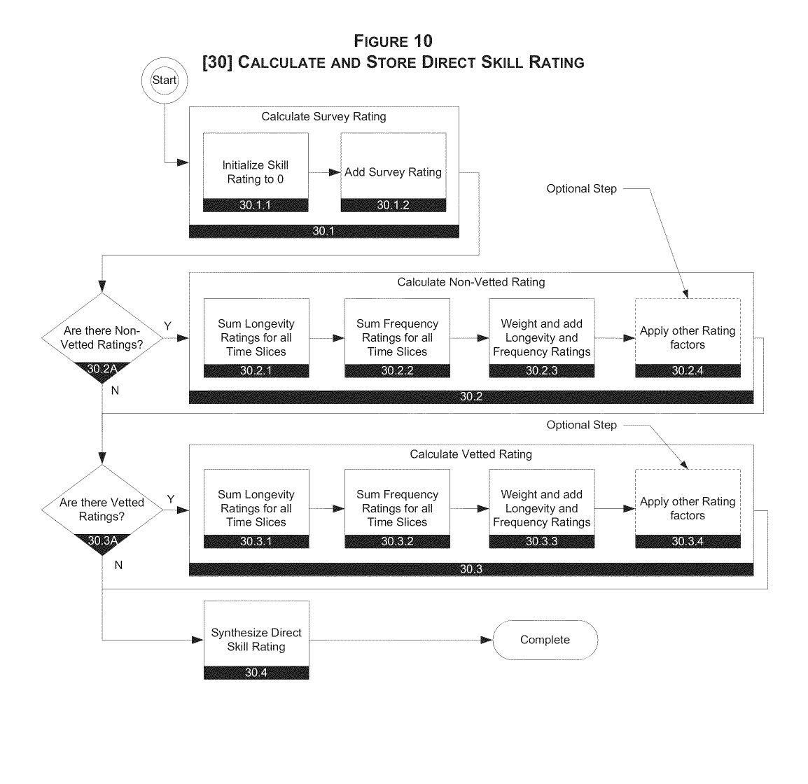

At a Block 30, the method synthesizes single Skill Rating based on the analysis of the experience reports garnered at Block 10 and Block 20. FIG. 10 is a detail flow chart describing the process utilized by the method to synthesize and reconcile the myriad experience reports.

At a Block 30.1, a minimum amount of credit is assigned to each skill present in the any of the experience reports garnered at Block 10.

At a Block 30.1.1, the method resets the amount of credit to zero for the skill currently being analyzed.

At a Block 30.1.2, the method assigns a minimum amount of credit to the skill currently being analyzed, for example, if the skill ratings are normalized from 1 to 1000 the method may assign an initial rating of 1.

At a Decision Block 30.2A, the method determines if there are instances of self-reported experience reports experience present in an individual's set of experience reports garnered at a Block 10B.

At a block 30.2, the method synthesizes a credit value for each skill present in the self-reported experience reports garnered at Block 10B.

At a block 30.2.1, the method combines the Longevity Scores all “Time Slices” to create a Longevity Rating based on data previously garnered by the method from self-reported experience.

At a block 30.2.2, the method combines the Frequency Scores for all “Time Slices” to determine a Frequency Rating based on data previously garnered by the method from self-reported experience.

At a block 30.2.3, the method combines the Longevity Rating with the Frequency Rating. The method may combine these two ratings based upon the requirements of the task for which the candidate is being matched. For example, if the task against which the analysis is being performed is to oversee the multi-year construction of a single commercial manufacturing facility, the method will more heavily weight those experience reports containing long-term engagements (Longevity). Similarly, if the task is instead to oversee the construction of fifty condominiums, the method will more heavily weight those experience reports containing short-term engagements (Frequency).

At a block 30.2.4, the method incorporates any other factors that will increase the ability of the method to compare an individual's experience reports to the requirements of a task. For example, the method may increase the skill rating for an individual who has recently attended training classes for skills that are relevant to the task requirements.

At a Decision Block 30.3A, the method determines if there are instances of vetted experience reports present in an individual's set of experience reports garnered at a Block 10C.

At a block 30.3, the method synthesizes a credit value for each skill present in the vetted experience reports garnered at Block 10C.

At a block 30.3.1, the method combines the Longevity Scores all “Time Slices” to determine a Longevity Rating based on data previously garnered by the method from vetted experience.

At a block 30.3.2, the method combines the Frequency Scores for all “Time Slices” to determine a Frequency Rating based on data previously garnered by the method from vetted experience.

As with the non-vetted experience considered by the method at block 30.2.3, at a block 30.3.3, the method combines the Longevity Rating with the Frequency Rating. The method may combine these two ratings based upon the requirements of the task for which the candidate is being matched. For example, if the task against which the analysis is being performed is to oversee the multi-year construction of a single commercial manufacturing facility, the method will more heavily weight those experience reports containing long-term engagements (Longevity). Similarly, if the task is instead to oversee the construction of fifty condominiums, the method will more heavily weight those experience reports containing short-term engagements (Frequency).

At a block 30.3.4, the method incorporates any other factors that will increase the ability of the method to compare an individual's experience reports to the requirements of a task. For example, the method may increase the skill rating for an individual who has recently achieved a professional or industry certification relating to a skill or set of skills.

At a block 30.4, the method combines the ratings garnered at Blocks 30.1, 30.2, and 30.3 into a single summary Skill Rating. The method will combine the ratings based on the needs of the entity utilizing the method, or a computer implementing the method in the performance of the analysis of a set of individuals' experience reports. For example, if the Corporation does not have the resources on-hand to vet experience reports, the method can be configured to allow the Vetted Ratings and Non-Vetted Ratings to contribute equally to the overall Skill Rating; however, if the Corporation can vet every report, the method can be configured to allow the Vetted Ratings to contribute to a larger percentage of the overall Skill Rating than the Non-Vetted Ratings.

At a Block 40, the method examines the skills present in an individual's reports of experience and calculates a set of ratings for skills that are similar or related each particular skill.

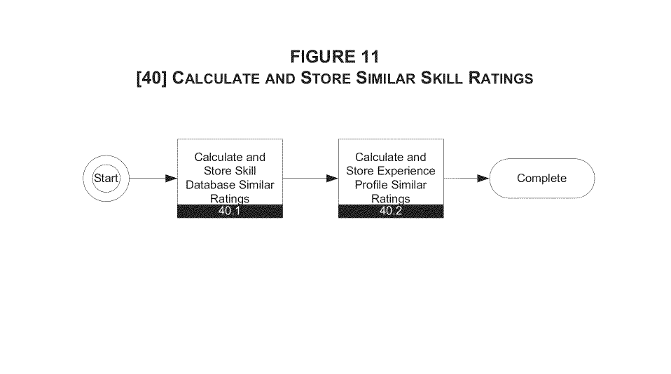

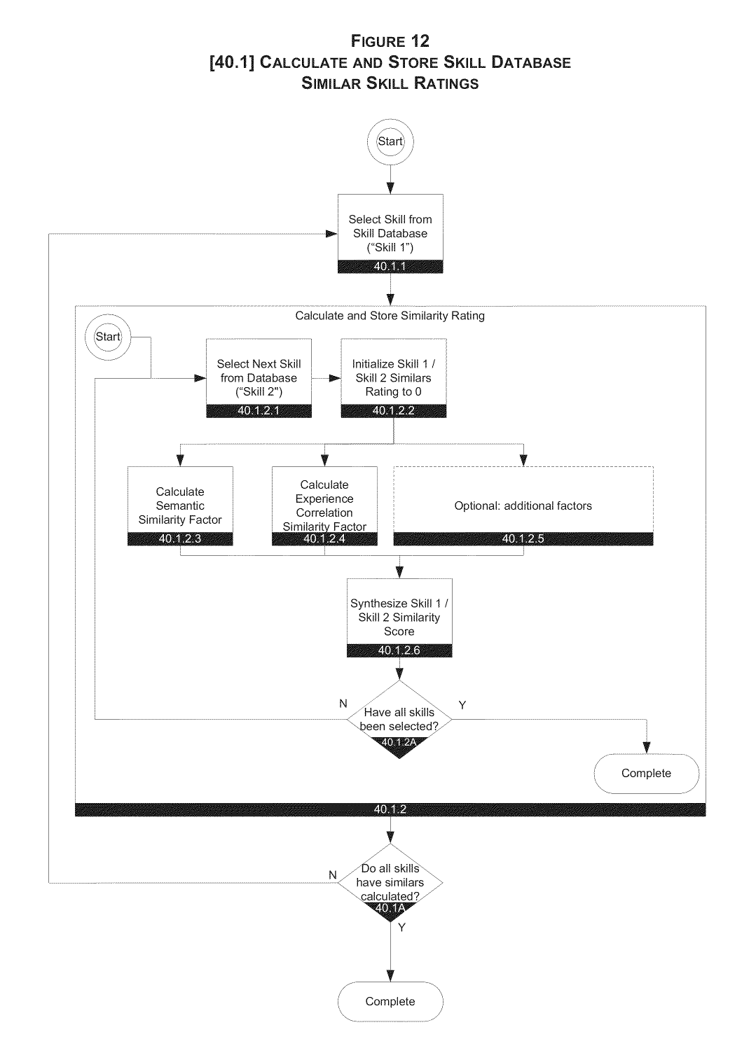

FIG. 11 is a detailed flow chart, expanding the method at block 40, which describes how the method defines and quantifies varying degrees of similarity amongst the skills present within an individual's reports of experience. The method utilizes a two-step process. First, at a Block 40.1, the method considers all of the skills present in a database that is designed for this purpose, and builds relationships between them that represent a similarity measure. The method employs a separate process to establish these similarity measures as shown in FIG. 12.

At a Block 40.1.1, the method considers an individual skill, referred to as “Skill 1,” that resides in a database of skills. This database can be a dedicated database created and maintained by the method, or an independent database that is made accessible to the method, which is created and maintained by another method or computer.

At a Block 40.1.2, the method calculates and stores a set of similarity ratings for Skill 1, further described below.

At a Block 40.1.2.1, the method considers a second skill, referred to as “Skill 2,” that resides in the same database of skills as Skill 1.

At a Block 40.1.2.2, the method initializes the Similarity Rating between Skill 1 and Skill 2 to a value of 0.

The method now considers multiple dimensions of similarity between Skill 1 and Skill 2 in order to properly characterize, and ultimately quantify, the degree to which these two skills are similar. The method normalizes the different similarity measures to a decimal value between 0 and 1, inclusive, where 0 indicates no similarity between Skill 1 and Skill 2, and 1 indicates that the two skills are identical.

At a block 40.1.2.3, the method calculates a value that corresponds to the semantic similarity between Skill 1 and Skill 2. The semantic similarity value is based upon how similar the two skills' descriptions are to one another. For example, consider a description for Skill 1 as “Database Architecture.” If Skill 2's description was “Database Administration,” the method may determine that two skills have a Semantic Similarity Factor of 0.5, since half of the words in the two skills' descriptions are identical.

It is important to note that Semantic Similarity garners one measure in determining an overall Similarity Rating, but if used as the sole measure, it is error prone. For example, consider again that a description stored in the skill database for Skill 1 is “Database Architecture.” Now, consider that Skill 2's description might be “House Architecture,” which would be ascribed to an individual who possesses none of the skills or capabilities needed to fulfill a job requiring someone proficient in Database Architecture; quite simply, these are not similar skills. However, extending the previous example which considered Skill 2 as “Database Administration,” the Semantic Similarity rating would be calculated as 0.5, which would indicate that “Database Architecture” and “House Architecture” are, in fact, similar. As such, the method necessarily considers additional similarity factors in the ultimate determination of the overall Similarity Rating between any two individual skills.

At a Block 40.1.2.4, the method ascribes a similarity rating to those skills that appear in the same reports of experience. In any skilled profession, multiple skills are used in concert to achieve results. An automotive mechanic must be adept with computer diagnostic equipment, welding, and myriad hand tools to complete the tasks presented to her; similarly, an office worker will necessarily be an expert in the specific combination of computer applications, such as word processors, spreadsheet tools, and accounting systems, to complete the tasks required of their role. And so it is that certain collections of skills are often developed in concert with one another. The method exploits this fact to establish an Experience Correlation Similarity Factor, such that if an individual has proficiency in one of the skills in a known collection, there will be some capability in the other skills residing in that same collection.

The method exploits the reports of experience accessible to it to establish the Experience Correlation Similarity Factor. If Skill 1 always appears in the same experience reports as Skill 2, the method will ascribe a value of 1; if Skill 1 appears in 90% of the experience reports as Skill 2, the method will ascribe a value of 0.9; and so on.

In addition to the three dimensions of similarity described by Blocks 40.1.2.3, 40.1.2.4, and 40.1.2.5, there may be other factors that capture and incorporate additional, relevant measures of similarity. These additional measures can be incorporated by the method at a Block 40.1.2.5. For example, a separate method, either bespoke or commercially available, may be applied to the skill database in order to determine similarity measures. For example, one such separate method might be an internet search engine such as Google or Microsoft's Bing. The scope of these search engines could be limited to only those values in the skill database, and the match results returned by searching for an individual skill could be considered by the method as an additional similarity measure.

Once the method has calculated the set of independent similarity ratings, the method will then synthesize them into a single similarity rating at a Block 40.1.2.6. The method will combine the different similarity ratings by any suitable means, such as a simple arithmetic average, or a normalized, weighted sum, to allow some factors to contribute more heavily to the overall similarity rating than others.

At a Decision Block 40.1.2A, the method determines if all skills present in the skill database have been considered with regard to their similarity to Skill 1. If there are unconsidered skills residing in the database, the Method will repeat the loop comprising Blocks 40.1.2.1, 40.1.2.2, 40.1.2.3, 40.1.2.4, 40.1.2.5, 40.1.2.6, and 40.1.2.7, until the entire database of skills has been considered and compared to Skill 1.

The number of relationships a skill will garner is fixed, and is based on the total number of skills present in the database; for example, if a database has ten individual skills, then nine similarity values will comprise any individual skill's complete set. At a Decision Block 40.1A, the method determines if all skills present in the skill database have complete a complete set of similarity values; if not, the method will repeat the loop comprising Blocks 40.1.1 and 40.1.2.

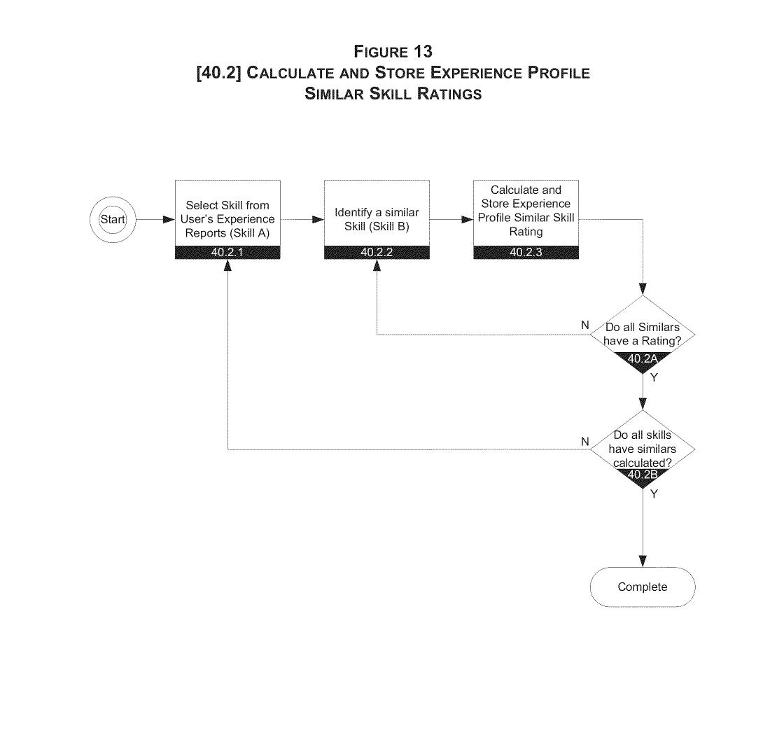

The method's second step in defining and quantifying skill similarity is shown at a block 40.2, where the similarity relationships garnered at a block 40.1 are utilized by the method to associate ratings with an individual's experience profile for those skills that are similar, but not identical to, the skills present in that individual's reports of experience. This process implemented in block 40.2 is further described by FIG. 13.

At a Block 40.2.1, the method considers an individual skill, referred to henceforth as “Skill A,” present in individual's reports of experience, for which the method has already calculated a suitable rating.

At a Block 40.2.2, the method identifies a skill similar to Skill 1, referred to henceforth as “Skill B,” by examining the database containing the similarity relationships previously calculated by the method at a Block 40.1. The method considers Skill B to be similar to Skill A if the similarity relationship calculated by the method between those two skills is any number greater than zero.

Once a similar skill is identified by the method, the method will then supplement an individual's reports of experience to contain this similar skill. However, the skill ratings for those skills that are added in this way by the method must necessarily be handicapped relative to the set of skills natively residing in an individual's reports of experience, garnered through other means. The method exploits the similarity relationships previously quantified by the method as similarity ratings to give an individual appropriate credit for the set of similar skills.

At a block 40.2.3, the method calculates the similarity rating for Skill B, identified at Block 40.2.2. Because all similarity ratings previously calculated by the method are values between zero and one, the method multiplies the Skill A/Skill B similarity rating to the skill rating for the Skill A, selected at block 40.2.1. In this way, the method will give the individual a portion of the credit for similar skills in a manner that is consistent with the amount of similarity previously determined by the method.

At a Decision Block 40.2A the method continues to supplement an individual's profile with similar skill ratings until all of the skills similar to Skill A have been considered.

At a Decision Block 40.2B, the method continues to supplement an individual's profile with similar skill ratings until all of the skill present in an individual's reports of experience have been considered.

At a Block 40A, the method repeats the calculation of the Direct Skill Rating and Similar Skill Ratings for every skill present in a candidate's reports of experience.

Once calculated by the method, the Skill Ratings can be used in combination with other measurable attributes to form a complete picture of candidate suitability for a particular task. For example, the skill ratings may be considered in addition to geographic proximity, hourly billing rate, availability, and other factors when making choosing a candidate. These easily measured quantitative factors can now be reconciled definitively and impartially with skill aptitude when identifying the ideal permutation of task and resource combinations.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method is method is performed upon a computer server in response to specific instructions stored on a non-transitory computer-readable medium, the method for providing employee information in response to a query of an employer database; the method comprising:
receiving, at least one network-connected server, a query comprising at least one requested attribute;
resolving the at least one employee attribute, to select, from a matrix of attributes the employer database contains, at least one corresponding an attribute; and
retrieving data based upon at least one corresponding attribute, from the database, the retrieved data comprising records of selected employees the employee database contains.

2. A non-transitory computer readable medium comprising instructions, which when executed by a process perform a method, the method comprising:
receiving, at least one network-connected server, a query comprising at least one requested attribute;
resolving the at least one employee attribute to select, from a matrix of attributes the employer database contains, at least one corresponding an attribute; and
retrieving data based upon at least one corresponding attribute, from the database, the retrieved data comprising records of selected employees the employee database contains.

3. The non-transitory computer readable medium of claim 2, wherein the received query is to fill a new job with the requesting company.

4. The non-transitory computer readable medium of claim 2, wherein the resolving is by fuzzy matching and includes a matching score wherein the score is determined by comparing the requested attributes to the employee attributes.

5. The non-transitory computer readable medium of claim 4 wherein the matching score is determined based upon possessing a required certification.

6. The non-transitory computer readable medium of claim 4 wherein the matching score a requested attribute for a journeyman in a trade will allow a match an apprentice in the trade while reflecting a lower matching score that a journeyman in the trade would receive.

7. A non-transitory computer readable medium comprising instructions, which when executed by a process perform a method, the method comprising:
logging into a web-based active service page using an identity having associated with it, a role-based security profile;
positing a query including at least one requested attribute, the query to locate at least one employee in an employer database;
resolving the at least one employee attribute to select, from a matrix of attributes the employer database contains, at least one corresponding an attribute;
developing access to the database consistent with the role-based security profile;
identifying at least one employee whose records are stored in the database, wherein the employee has at least one employee attribute matching the corresponding attribute.

8. A non-transitory computer readable medium comprising instructions, which when executed by a process, perform a method for providing employee information in response to a query, the method comprising:
receiving the query comprising at least one requested attribute at the network-connected server;
resolving the at least one employee attribute to select, from a matrix of attributes the employer database contains, at least one corresponding an attribute: and
identifying within the database candidate employee data having at least one employee attribute to match the corresponding attribute.
